(19) United States
(12) Patent Application Publication
(10) Pub. No.: US 2024/0119454 A1
(43) Pub. Date: Apr. 11, 2024

(54) TRAVELER THEMATIC DESTINATION SEGMENTATION

(71) Applicant: Visa International Service Association, San Francisco, CA (US)

(72) Inventors: Naryman el-Sayed Mohamed Ahmed DARWISH, New Cairo (EG); Manoj NAIR, Dubai (AE); Asli Nur TOPCU, Dubai (AE); Ghanashyama MAHANTY, Dubai (AE)

(73) Assignee: Visa International Service Association, San Francisco, CA (US)

(21) Appl. No.: 18/482,578

(22) Filed: Oct. 6, 2023

Related U.S. Application Data
(60) Provisional application No. 63/378,638, filed on Oct. 6, 2022.

(51) Int. Cl. G06Q 20/40; G06Q 20/38

(52) U.S. Cl. CPC G06Q 20/4014; G06Q 20/389

(57) ABSTRACT

An event driven system and method for traveler thematic destination segmentation are disclosed. The event driven system includes a processor and a memory coupled to the processor to store machine instructions executable by the processor. When executed by the processor the machine instructions cause the processor to extract clearance and settlement transaction data from a database, prepare the clearance and settlement transaction data, clean geo-data associated with the clearance and settlement transaction data, enrich and standardize the geo-data, scrape theme data associated with a trip from a public network, verify the relevant theme data associated with the trip, enrich and standardize geo-data associated with the relevant theme data associated with the trip, and map the enriched and standardized geo-data associated with the clearance and settlement transaction data to the enriched and standardized geo-data associated with the relevant theme data associated with the trip.

### CROSS-REFERENCE TO RELATED APPLICATION

This application claims the benefit of and priority under 35 U.S.C. § 119(e) to U.S. Provisional Application Ser. No. 63/378,638 filed Oct. 6, 2022, entitled “TRAVELER THEMATIC DESTINATION SEGMENTATION,” the contents of which is hereby incorporated by reference in its entirety herein.

### TECHNICAL FIELD

The present disclosure is generally related to geolocation data, analytics, and modeling to develop traveler thematic destination segmenting.

### SUMMARY

In various aspects, the present disclosure provides an event driven system for traveler thematic destination segmentation. The event driven system comprises a processor; a memory coupled to the processor, wherein the memory stores machine instructions executable by the processor; wherein when executed by the processor the machine instructions cause the processor to: extract clearance and settlement transaction data from a clearance and settlement database; prepare the clearance and settlement transaction data; clean geo-data associated with the clearance and settlement transaction data; enrich and standardize the geo-data associated with the clearance and settlement transaction data; scrape relevant theme data associated with a trip from a public network; verify the relevant theme data associated with the trip; enrich and standardize geo-data associated with the relevant theme data associated with the trip; and map the enriched and standardized geo-data associated with the clearance and settlement transaction data to the enriched and standardized geo-data associated with the relevant theme data associated with the trip.

In one aspect, the present disclosure provides, when executed by the processor the machine instructions cause the processor to store the enriched and standardized geo-data associated with the clearance and settlement transaction data in a first database; and store the enriched and standardized geo-data associated with the relevant theme data associated with the trip in a second database.

In another aspect, the present disclosure provides, when executed by the processor the machine instructions cause the processor to retrieve the enriched and standardized geo-data associated with the clearance and settlement transaction data from the first database; and retrieve the enriched and standardized geo-data associated with the relevant theme data associated with the trip from the second database.

In yet another aspect, the present disclosure provides, when executed by the processor the machine instructions cause the processor to define at least one of a trip, a trip theme, or a traveler segment; store trip information in a third database; analyze each theme and traveler segment to generate analysis data; and store the analysis data in a fourth database.

In various aspects, the present disclosure provides an event driven method for traveler thematic destination segmentation. The method comprises extracting, by a processor, clearance and settlement transaction data from a clearance and settlement database; preparing, by the processor, the clearance and settlement transaction data; cleaning, by the processor, geo-data associated with the clearance and settlement transaction data; enriching and standardizing, by the processor the geo-data associated with the clearance and settlement transaction data; scraping, by the processor, relevant theme data associated with a trip from a public network; verifying, by the processor, the relevant theme data associated with the trip; enriching and standardizing, by the processor, geo-data associated with the relevant theme data associated with the trip; and mapping, by the processor, the enriched and standardized geo-data associated with the clearance and settlement transaction data to the enriched and standardized geo-data associated with the relevant theme data associated with the trip.

In one aspect, the present disclosure provides the event driven method comprises storing, by the processor, the enriched and standardized geo-data associated with the transaction data in a first database; and storing, by the processor, the enriched and standardized geo-data associated with the relevant theme data associated with the trip in a second database. Further, the event driven method may comprise retrieving, by the processor, the enriched and standardized geo-data associated with the transaction data from the first database; and retrieving the enriched and standardized geo-data associated with the relevant theme data from the second database.

In another aspect, the present disclosure provides the event driven method comprises defining, by the processor, at least one of a trip, a trip theme, or traveler segment; storing, by the processor, trip information in a third second database; analyzing, by the processor, each trip, theme, or persona segment to generate analysis data; and storing, by the processor, the analysis data in a fourth database.

In yet another aspect, the present disclosure provides the cleaning, by the processor, of the geo-data associated with the transaction data comprises determining, by the processor, a transaction place; searching, by the processor, for the transaction place on a public geographic database service; determining, by the processor, whether the transaction place exists in a transaction country; performing, by the processor, text permutations on the transaction place; performing, by the processor, text permutations on the transaction country; extracting, by the processor, standardized geo-data about the transaction place; and storing, by the processor, clean transaction geo-data in the first database. Further, the event driven method may comprise retrieving, by the processor, global merchant repository (GMR) location of the transaction place; and searching, by the processor, for coordinates of the transaction place on the public geographic database service.

In yet another aspect, the present disclosure provides the event driven method comprises creating, by the processor, a themes data repository. Further, the event driven method may comprise searching, by the processor, unstructured data on the public network; determining, by the processor, whether a transaction place is touristic and relevant to a theme; searching, by the processor, on the public geographic database service.

In yet another aspect, the present disclosure provides the event driven method comprises retrieving, by the processor, a normalized transaction place; retrieving, by the processor, a normalized destination place; and comparing, by the processor, geographic polygons associated with the normalized transaction place and the normalized destination place. Further, the event driven method may comprise determining, by the processor, whether the normalized transaction place and the normalized destination place share a country; if the normalized transaction place and the normalized destination place share a country, the event driven method further comprises: labeling, by the processor, the transaction with a theme type; storing, by the processor, clean transaction geo-data in the first database. Further, the event driven method may comprise determining, by the processor, whether there is an overlay between the geographic polygons associated with the normalized transaction place and the normalized destination place; calculating, by the processor, a Haversine distance between coordinates of the normalized transaction place and the normalized destination place; and if the distance between the normalized transaction place and the normalized destination place is within a predetermined range, the event driven method further comprises: labeling, by the processor, the transaction with a theme type; and storing, by the processor, clean transaction geo-data in the first database.

In yet another aspect, the present disclosure provides an event driven system for segmenting traveler thematic destination data, the event driven system comprising: a processor; a memory coupled to the processor, wherein the memory stores machine instructions executable by the processor; wherein when executed by the processor the machine instructions cause the processor to: extract clearance and settlement transaction data from a clearance and settlement database; clean geo-data associated with the clearance and settlement transaction data; enrich and standardize the geo-data associated with the clearance and settlement transaction data; scrape theme data associated with a plurality of predefined destination themes from a public network; verify the theme data is relevant for a geographic location corresponding to geo-data associated with of the theme data; enrich and standardize the geo-data associated with the theme data; map the enriched and standardized geo-data associated with the clearance and settlement transaction data to the enriched and standardized geo-data associated with the theme data to create analysis data based on the clearance and settlement transaction data; and generate an analysis report based on the analysis data and an input criterion.

In yet another aspect, the present disclosure provides an event driven method for traveler thematic destination segmentation, the method comprising: extracting, by a processor, clearance and settlement transaction data from a clearance and settlement database; cleaning, by the processor, geo-data associated with the clearance and settlement transaction data; enriching and standardizing, by the processor the geo-data associated with the clearance and settlement transaction data; scraping, by the processor, theme data associated with a plurality of predefined destination themes from a public network; verifying, by the processor, the theme data is relevant for a geographic location corresponding to geo-data associated with of the theme data; enriching and standardizing, by the processor, geo-data associated with the theme data; mapping, by the processor, the enriched and standardized geo-data associated with the clearance and settlement transaction data to the enriched and standardized geo-data associated with the theme data to create an analysis data based on the clearance and settlement transaction data; and generating, by the processor, an analysis report based on the analysis data and an input criterion.

In yet another aspect, the present disclosure provides a non-transitory computer-readable medium comprising instructions stored thereon, when executed by one or more processors, cause the one or more processors to: extract clearance and settlement transaction data from a clearance and settlement database; clean geo-data associated with the clearance and settlement transaction data; enrich and standardize the geo-data associated with the clearance and settlement transaction data; scrape theme data associated with a plurality of predefined destination themes from a public network; verify the theme data is relevant for a geographic location corresponding to geo-data associated with of the theme data; enrich and standardize geo-data associated with the theme data; map the enriched and standardized geo-data associated with the clearance and settlement transaction data to the enriched and standardized geo-data associated with the theme data to create an analysis data based on the clearance and settlement transaction data; and generate an analysis report based on the analysis data and an input criterion.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 is a diagram illustrating traveler thematic destination segmentation, according to at least one aspect of the present disclosure.

FIG. 2 is a system for segmenting traveler thematic destinations, according to at least one aspect of the present disclosure.

FIG. 3 is a diagram of an overall event driven system for segmenting traveler thematic destination, according to at least one aspect of the present disclosure.

FIG. 4 illustrates a method for cleaning and standardizing geo-data information, according to at least one aspect of the present disclosure.

FIG. 5 is a chart of a clean transaction geo-data information data structure according to the method shown in FIG. 4, according to at least aspect of the present disclosure.

FIG. 6 illustrates a method for creating a themes data repository, according to at least one aspect of the present disclosure.

FIG. 7 illustrates a method of creating a beaches themes data repository, according to at least one aspect of the present disclosure.

FIG. 8 is a chart of a beaches themes data repository created according to the method shown in FIG. 7, according to at least aspect of the present disclosure.

FIG. 9 is a method of mapping themes to transactions, according to at least one aspect of the present disclosure.

FIG. 10 is a chart showing definitions created based on transaction sequences, according to at least one aspect of the present disclosure.

FIG. 11 is an example trip definition table, according to at least one aspect of the present disclosure.

FIGS. 12A and 12B show a first chart 1200 and a second chart 1250 defining the purpose of a trip, according to at least one aspect of the present disclosure.

FIG. 13 is a chart depicting a combination of destination theme and trip reason, according to at least one aspect of the present disclosure.

FIGS. 14A and 14B are an exemplary analysis report diagram 1400 illustrating profile data based on trips, according to at least one aspect of the present disclosure.

FIG. 15 is a block diagram of a computer apparatus with data processing subsystems or components, according to at least one aspect of the present disclosure.

FIG. 16 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

A “consumer” may include an individual, customer, or a user that may be associated with one or more personal accounts and/or consumer devices. The consumer may also be referred to as a cardholder, account holder, or user.

Reference to “a device,” “a server,” “a processor,” and/or the like, as used herein, may refer to a previously recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

The terms “point-of-sale system,” “POS system,” or “POS terminal,” as used herein, may refer to one or more computers and/or peripheral devices used by a merchant to engage in payment transactions with customers, consumers, or users, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer. POS terminals may include mobile devices.

A “primary account number (PAN)” may be a variable length, (e.g., 13 to 19 digits) industry standard-compliant account number that is generated within account ranges associated with a BIN by an issuer.

A “processing network” may include an electronic system used to accept, transmit, or process transactions made by devices. The processing network may transfer information among transacting parties (e.g., issuers, acquirers, merchants, device users, etc.).

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities.

The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

A “transaction amount” may be the price assessed to the consumer for the transaction. The transaction amount condition may be a threshold value (e.g., all transactions for an amount exceeding $100) or a range (e.g., all transactions in the range of $25-$50). For example, a user may wish to use a first routing priority list for a transaction for an amount in the range of $0.01-$100 and a second routing priority list for a transaction for an amount exceeding $100.

The term “transaction data” may include any data associated with one or more transactions. In some embodiments or aspects, the transaction data may merely include an account identifier (e.g., a PAN) or payment token. Alternatively, in other embodiments or aspects, the transaction data may include any information generated, stored, or associated with a merchant, consumer, account, or any other related information to a transaction. For example, transaction data may include data in an authorization request message that is generated in response to a payment transaction being initiated by a consumer with a merchant. Alternatively, transaction data may include information associated with one or more transactions that have been previously processed and the transaction information has been stored on a merchant database or other merchant computer. The transaction data may include an account identifier associated with the payment instrument used to initiate the transaction, consumer personal information, products or services purchased, or any other information that may be relevant or suitable for transaction processing. Additionally, the transaction information may include a payment token or other tokenized or masked account identifier substitute that may be used to complete a transaction and protect the underlying account information of the consumer.

As used herein, the term “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting embodiments or aspects, a transaction processing system may include one or more server computers with one or more processors and, in some non-limiting embodiments or aspects, may be operated by or on behalf of a transaction service provider.

A “user” may include an individual. In some embodiments or aspects, a user may be associated with one or more personal accounts and/or mobile devices. The user may also be referred to as a cardholder, account holder, or consumer.

“OpenStreetMap®” is a collaborative project to create a free editable geographic database of the world. The geo-data underlying the maps is considered the primary output of the project.

“Google® Search” is a search engine provided by Google handling billions of searches per day. The order of search results returned by Google is based, in part, on a priority rank system called “PageRank”.

“ShapeFile” is a geospatial vector data format for geographic information system software. It is developed and regulated by ESRI® as a mostly open specification for data interoperability among ESRI® and other GIS software products. ESRI® is a company founded as the Environmental Systems Research Institute in 1969 as a land-use consulting firm. ESRI® is an international supplier of geographic information system software, web GIS and geo-database management applications. GIS is a geographic information system is a type of database containing geographic data, combined with software tools for managing, analyzing, and visualizing those data.

“Selenium®” is an open source umbrella project for a range of tools and libraries aimed at supporting browser automation. It provides a playback tool for authoring functional tests across most modern web browsers, without the need to learn a test scripting language.

“Google® Travel” is a trip planner service developed by Google® for the web.

“Traveler” is defined as a credit card user who uses his/her card for various transactions, and may perform cross border transactions, where the transactions are in a country different than the country where the traveler's credit card was issued.

“Trip” is defined as a sequence of transactions such as, for example, cross border transactions, where the transactions are done in a country different than the country where the credit card was issued.

“Travel Spend” is credit card spend related to travel such as, for example, cross border transactions, where the transactions are done in a country different than the country that issues transactions, or booking transactions such as, for example, lodging, vehicle rental, airlines, travel agencies.

“E-commerce” is the activity of electronically buying or selling of products on online services or over the Internet.

“Face-to-Face Transaction” is where a customer presents their debit/credit card to make a payment, which is processed by a payment processing network.

“Data Scraping” is a technique where a computer program extracts data from human-readable output coming from another program.

“Spatial Data Analysis” is defined as a set of techniques designed to find patterns, detect anomalies, or test hypotheses and theories, based on spatial data. Spatial data refers to data that describes different instances through space and time.

“Hadoop®” is an open-source software framework for storing data and running applications on clusters of commodity hardware. It is characterized by massive storage capabilities, enormous processing power and the ability to handle virtually limitless concurrent tasks or jobs.

“Python®” is a high-level, general-purpose programming language. Its design philosophy emphasizes code readability with the use of significant indentation. Python is dynamically-typed and garbage-collected. It supports multiple programming paradigms, including structured, object-oriented and functional programming.

“PySpark” is the Python API for Apache Spark, an open source, distributed computing framework and set of libraries for real-time, large-scale data processing.

“Hive” is a data warehouse software project built on top of Hadoop for providing data query and analysis. Hive gives an SQL-like interface to query data stored in various databases and file systems that integrate with Hadoop®.

“Beautiful Soup” is a Python software package for parsing HTML and XML documents. It creates a parse tree for parsed pages that can be used to extract data from HTML, which is useful for web scraping.

“Wikipedia®” is a multilingual free online encyclopedia written and maintained by a community of volunteers through open collaboration and a wiki-based editing system.

“Business/Corporate Card” is a type of credit card issued to a corporation. This means that the business entity, not the business owner, is legally responsible for all charges made on the card.

“Business-to-Business Transaction” is a type of e-commerce and is the exchange of products, services or information between businesses, rather than between businesses and consumers. A business-to-business transaction is conducted between two companies, such as wholesalers and online retailers.

“At Destination Spend” is defined as transactions done by a credit card holder in a country different than the country that issued the credit card to the credit card holder in addition to on-demand e-commerce transactions, e.g., groceries, transportation.

“UHNW Card” is a credit card issued to ultra-high-net-worth individuals having investable net assets in their name greater than a predetermined amount and highest tier of customers in the bank with premium benefits for them.

“Luxurious Hotel” is a hotel that provides a luxurious accommodation experience to the guest that is extremely comfortable, elegant, or enjoyable, especially in a way that involves great expense.

“GeoPandas” is an open source project to make working with geospatial data in python easier. GeoPandas extends the datatypes used by pandas to allow spatial operations on geometric types. Geometric operations are performed by shapely. GeoPandas further depends on FIONA for file access and MATPLOTLIB for plotting.

“GMR” is defined as Global Merchant Repository created by parsing and cleaning merchants' data provided from different resources especially acquirers files about merchants.

“Automation” describes a wide range of technologies that reduce human intervention in processes, namely by predetermining decision criteria, sub-process relationships, and related actions, as well as embodying those predeterminations in machines.

“P&B” refers to planning and budgeting for a trip, but is not exclusive to lodging transactions, airlines bookings, and travel agencies.

“On-Demand Transactions” is defined as transactions done by a credit card holder for services that will be consumed at time of payment, e.g., transportation, groceries.

“Workation®” originates from the words work and vacation. It is a combination of work and leisure to allow employees to relax and be more productive. It is working during vacation.

“VFR” refers to visiting friends and family while traveling. VFR travel is a form of travel involving a visit whereby either (or both) the purpose of the trip or the type of accommodation involves visiting friends and/or relatives.

“Haversine Distance” is calculated using the Haversine formula, which determines the great-circle distance between two points on a sphere given their longitudes and latitudes. Important in navigation, it is a special case of a more general formula in spherical trigonometry, the law of Haversines, that relates the sides and angles of spherical triangles. The Haversine Distance” (or great circle) distance is the angular distance between two points on the surface of a sphere. The first coordinate of each point is assumed to be the latitude, the second is the longitude, given in radians.

The major benefit from the present disclosure solution is that it traveler data analysis reports will help multiple travel-oriented entities like Airlines, Hotels, Government entities/Tourism boards grow their market share/presence and understand travelers' behaviors to drive other strategic decisions. The specific travel-oriented entity may provide input criterion such as a geographic destination, traveler segment, or travel industry (e.g., hotel, airline). The present disclosure analyses various inputs to understand travelers' behaviors and to help travel-oriented entities (airlines, hotels, government entities, and tourism boards) in growing their market share/presence. This is further accomplished by segmenting customers' trip to a specific destination theme and travel purpose to correctly target travelers based on their preferences and behavior. The present disclosure uses customer transaction data to draw a picture of his/her trip, activities while traveling to understand travel purpose and preferences. The present disclosure offers substantial benefits over the previous solutions that were only able to determine a limited amount of data about travelers such as who is traveling and what countries they travel to.

Various aspects of the present disclosure provide systems and methods for segmenting traveler thematic destination data. The systems and methods disclosed herein include segmenting travelers into specific themes/preferences based on a destination theme (e.g., mountains, islands, business hub, etc.) and travel type (e.g., leisure traveler, visiting friends or relatives (VFR), business traveler, etc.) that helps in theme-based targeting to attract more travelers into the destination. This can benefit multiple travel-oriented players in capturing more business through focused targeting of different customer segments with theme-based benefits. The present disclosure provides systems and methods for determining why consumers are traveling and what type of destinations they are traveling to. The systems and methods described herein further provide determining the touristic destinations customers travel to, standardizing and cleaning consumer financial transactions from transaction processing systems, and locations, and mapping customer transactions to touristic destinations. The systems and methods according to one aspect of the present disclosure, associate a traveler segment with a theme tag to each international trip in a specified time window.

The disclosed methods may be implemented by a novel combination of tools and technologies such as Data Accessing tools (e.g., Hadoop®), Data Processing tools (e.g., Python/PySpark [Scripting] and Hive), Data Scraping tools (e.g., Selenium®—Beautiful Soup), Spatial data sources (e.g., OpenStreetMap®—Google® Maps), and other data sources such as theme driven external data sources for data extraction and data verification. Other technologies may include spatial data analysis and text analysis tools. In various aspects, the present disclosure provides systems and methods for understanding the behavior of travelers and their preferences and segmenting them based on travel destination themes and traveler types. In theme-based targeting this helps attract more travelers to a destination by determining what attracts travelers to that destination and any gaps compared to similar destinations as well as determining new segments of consumers to target. This can particularly benefit multiple travel-oriented players in capturing more business through focused targeting of different consumer segments with theme-based benefits.

In various aspects, the present disclosure provides a geolocation data cleansing process for a financial transaction processing system. The geolocation data cleansing process performs a text permutation analysis to identify geolocation data corresponding to the missing Latin alphabet characters in a transaction city name. The geolocation data cleansing process also corrects spelling mistakes by employing search engine automation tools such as, for example, Google® Search using Selenium®. The geolocation data cleansing process normalizes the name of a place in all transactions by mapping the place to a web based street map and web automation tools such as, for example, OpenStreetMap® (OSM) using Nominatim and Google® Maps using Selenium®.

In various aspects, the present disclosure creates themed data sources. For each travel theme, the systems and methods build a customized data source that identifies places relevant to that theme, where the theme does not only meet the destination geological classification but also is considered a popular travel destination. The system and methods provide data extraction from multiple sources using web scraping tools such as, for example, Beautiful Soup, and text analysis to retrieve relevant information. However, the system and methods performs data scraping in compliance with the terms and conditions of the external data source that hosts the data. The system and methods also provide data verification to ensure tourism relevancy using automated web tools such as, for example, Selenium to search on search engines, map, and travel web sites such as, for example, Google® Search, Google® Maps and Google® Travel through Selenium.

In various aspects, the systems and methods according to the present disclosure provide geo-place identification and enrichment for both financial transaction systems processing and theme destinations using web based street maps such as, for example, OpenStreetMap®. The systems and methods described herein also can classify and theme the available financial transaction processing systems to the geolocation. The systems and methods described herein also can enrich location data using, for example, OSM by obtaining a complete location upper hierarchy and coordinates. The systems and methods described herein also can provide geo-data location by mapping a place to its polygon on, for example, Natural Earth Data free maps. The systems and methods described herein also can normalize both the location of the transaction processed by the financial transaction processing system and the theme destination location by using the same source.

In various aspects, the systems and methods according to the present disclosure provide transaction mapping to theme locations using spatial analysis techniques. Mapping between transaction place and theme place are achieved using, for example, a Haversine formula to measure distance between both locations and further tagging nearby places. Spatial analysis techniques through GeoPandas are employed to facilitate working with geospatial data and to check if the transaction place intersects with the theme place.

In various aspects, the systems and methods according to the present disclosure develop innovative Travel Personas using transaction proxies based on trip determination, start and end date, planning and booking before and during trip, both e-commerce and non-ecommerce transactions during the trip, and customer purchase behavior during the trip.

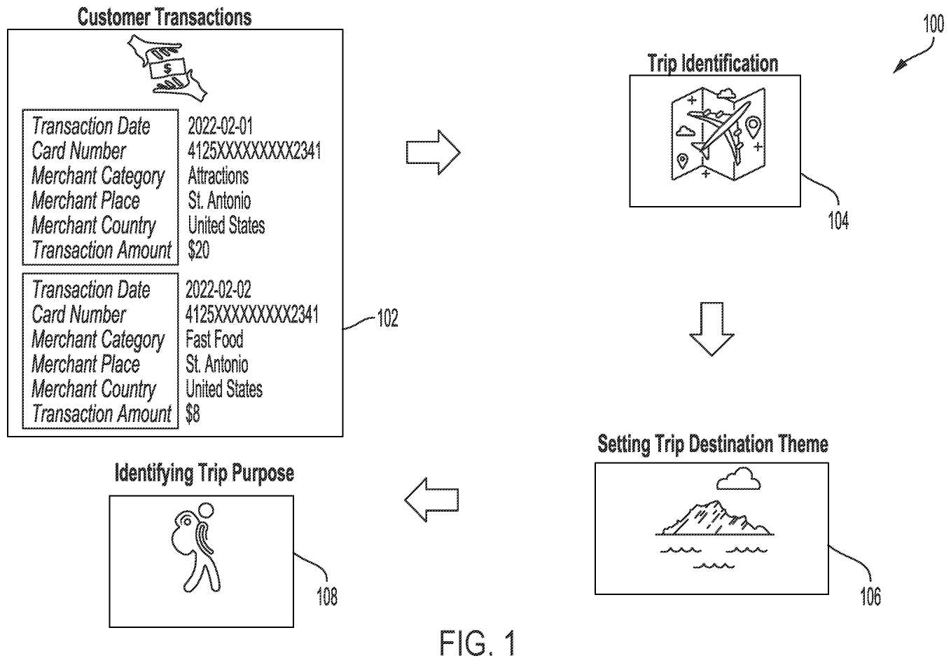

Having described general aspects of systems and methods for segmenting traveler thematic destinations, the disclosure now turns to the figures for a description of various example implementations of the systems and methods for segmenting traveler thematic destinations. Accordingly, turning now to the figures, FIG. 1 is a logic flow diagram 100 illustrating traveler thematic destination segmentation, according to at least one aspect of the present disclosure. In one aspect, the present disclosure provides a method for tracking customer transaction data 102, identifying a trip 104, setting a trip destination theme 106, and identifying a trip purpose 108. Customer transactions include tracking data such as transaction date, card number, merchant category, merchant place, merchant country, and transaction amount. Trip identification is determined by converting a sequence of transactions into a complete trip using data analysis. Trip destination themes such as, for example, mountains, islands, beaches, are determined based on transaction place and country. Trip purpose is determined based on transactions sequence and spend behavior. FIG. 1 further shows a method for receiving customer transaction data 102 from an external source and converts the sequence of customer transactions into a complete trip itinerary for a trip identification 104, based on an analysis of the time and geographic location of the transactions. The system evaluates additional external data related to the geographic location of the transactions to determine a trip destination theme 106 for the geographic location (e.g., mountains, island, city, beaches, etc.). Finally, the system identifies a purpose of the trip 108 based on a sequence of customer transaction data and the customer behavior.

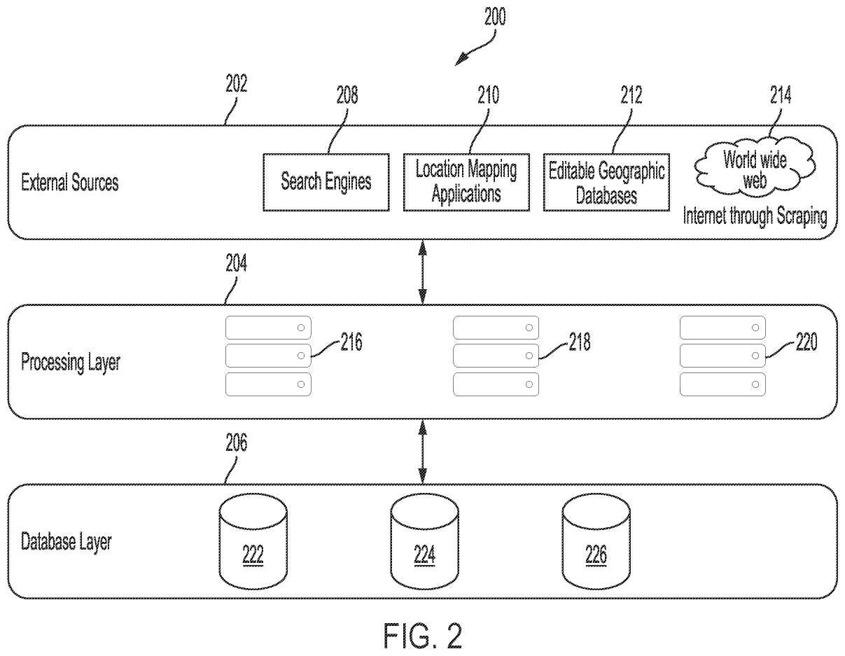

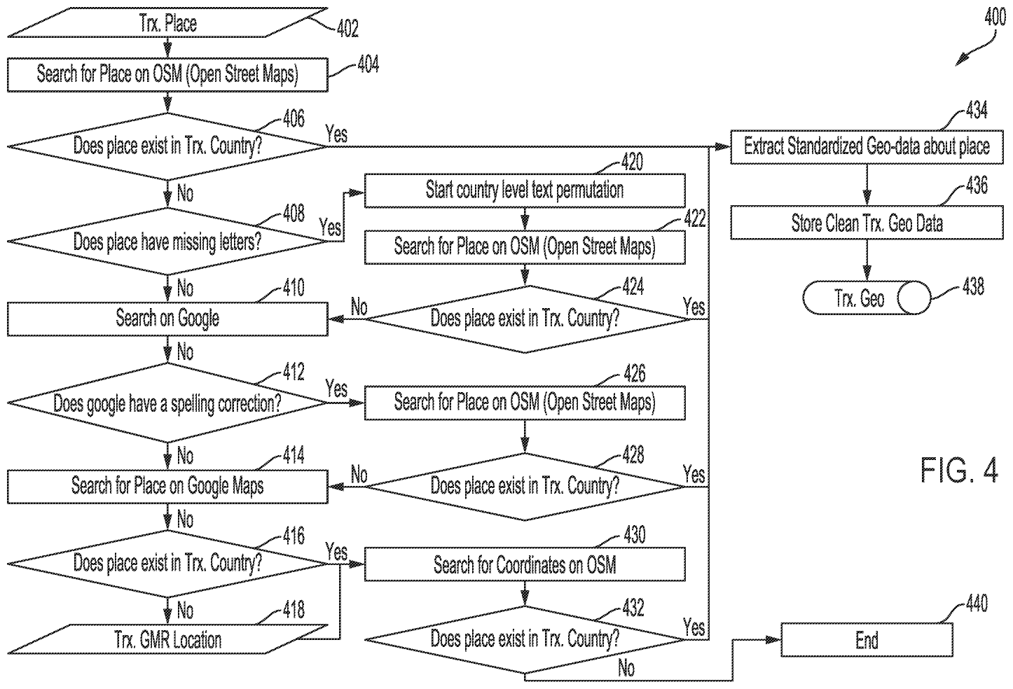

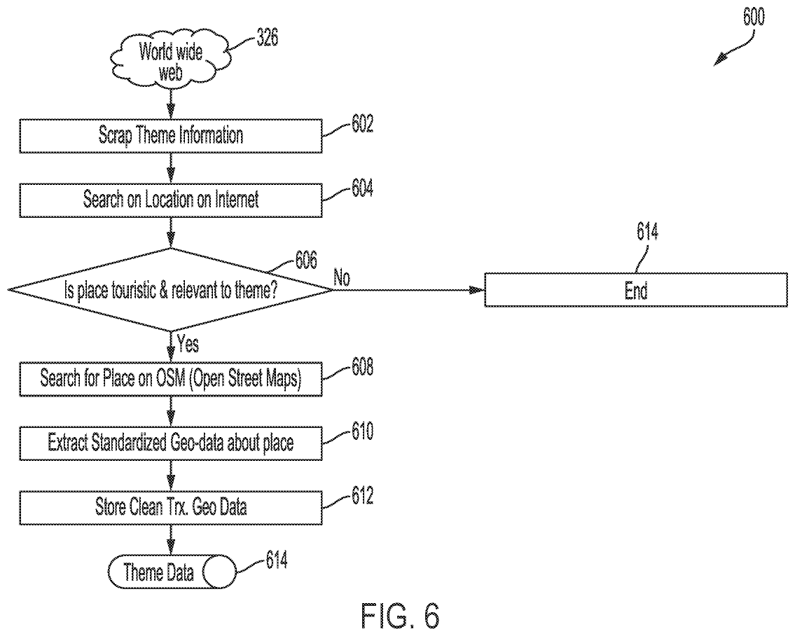

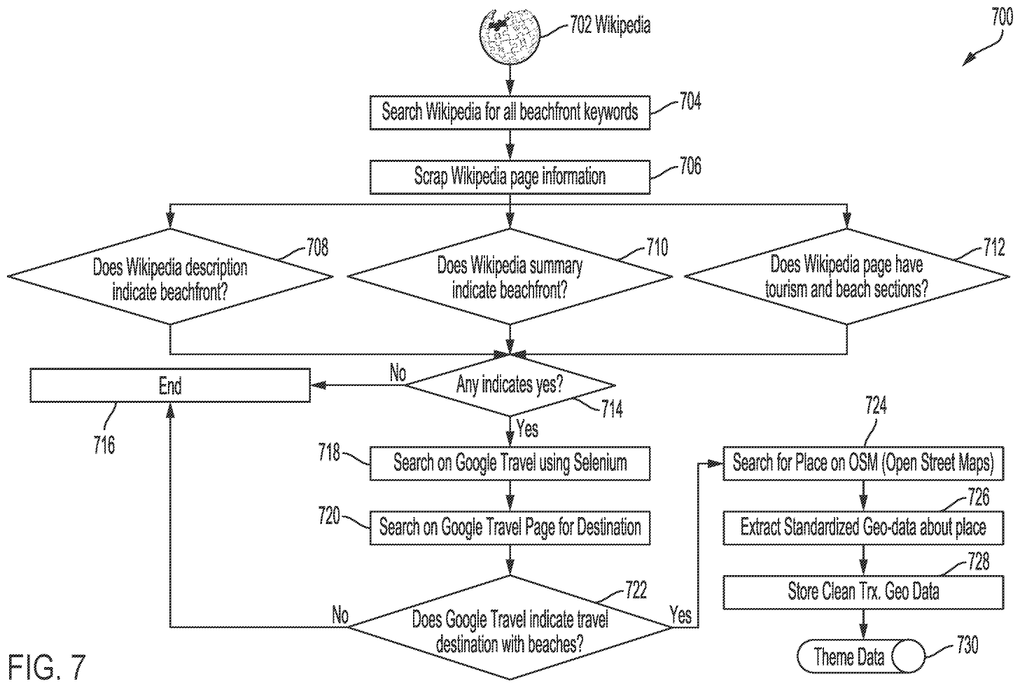

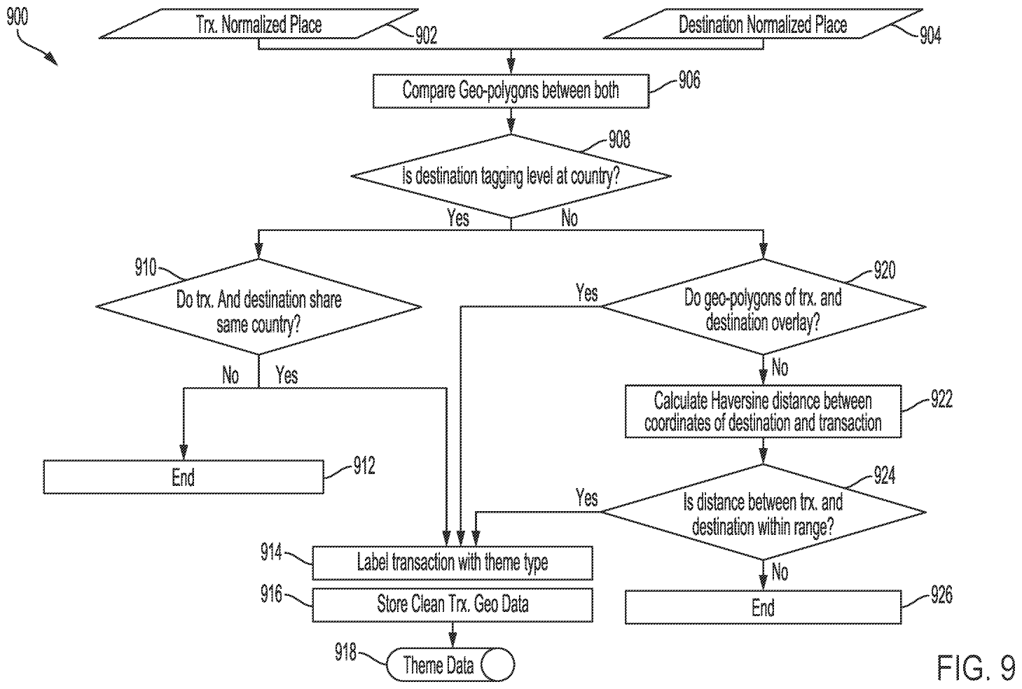

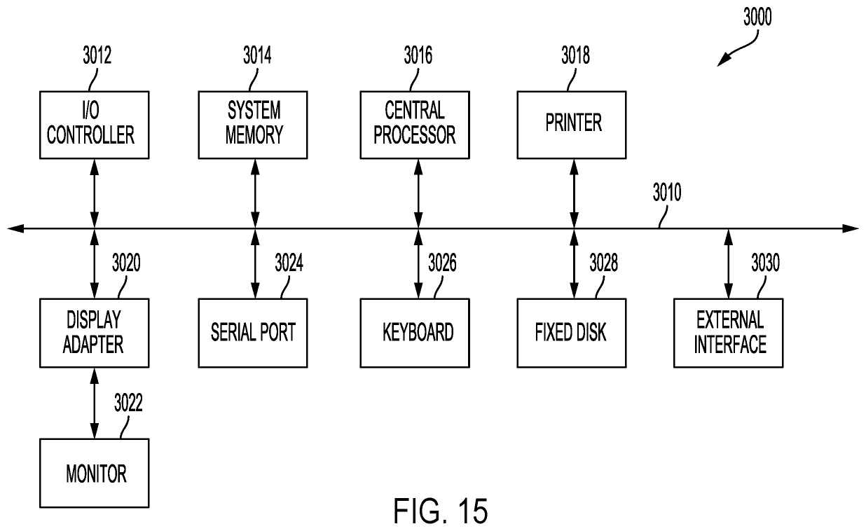

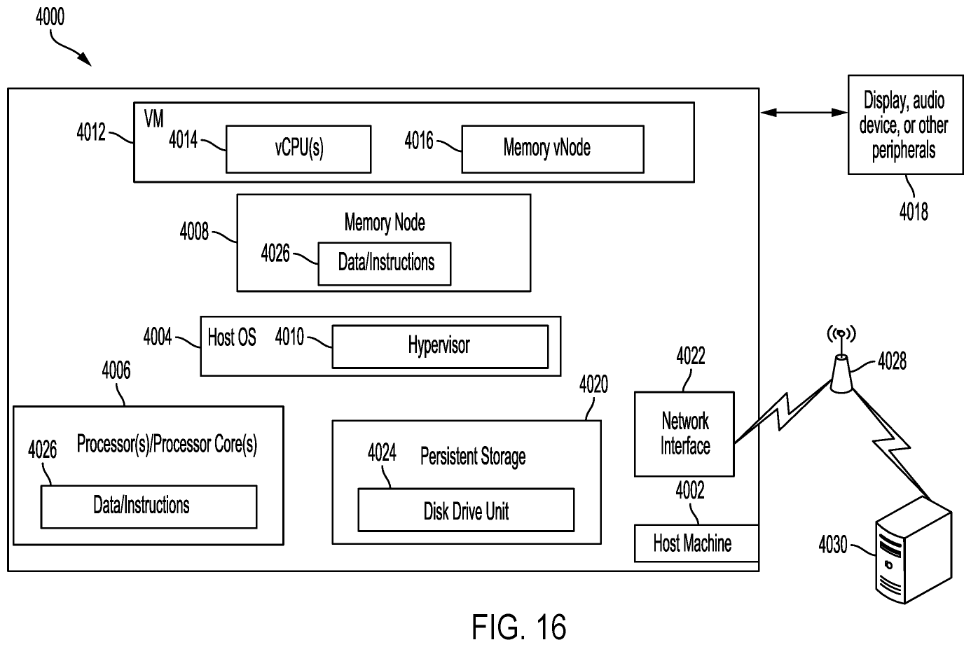

FIG. 2 is a system 200 for segmenting traveler thematic destinations, according to at least one aspect of the present disclosure. The system 200 includes external sources 202, a processing layer 204, and a database layer 206. The external sources 202 include various sources available on public networks and/or websites such as, for example, search engines 208 (e.g., Google® Search through Selenium), location mapping applications 210 (e.g., Google® Maps through Selenium®), editable geographic databases 212 (e.g., OpenStreetMap® through Nominatim API), and other theme driven external data sources through scraping the world wide web 214. The data scraping process may be implemented using a variety of different platforms including Selenium and Beautiful Soup. The processing layer 204 includes a real-time large-scale data processing system 216 (e.g., Pyspark), a general-purpose programming language 218 (e.g., Python®), and data warehouse software 220 (e.g., Hive). The database layer 206 communicably couples to the processing layer 204 and utilizes data accessing tools such as Hadoop®, for example, to store clearance and settlement transaction data (e.g., customer transaction data) in a data storage device 222 (e.g., clearance and settlement storage server). Additionally, the database layer may comprise a plurality of data storage devices of to store including a second data storage device 224 to store cleaned C&S transaction data (See FIG. 4) and a third data storage server 226 to store theme data (see FIGS. 7-9). The system 200 technologies include data scraping, spatial data analysis, and text analysis. In various aspects, the processing layer 204 may be implemented with the computer apparatus 3000 comprising data processing subsystems or components shown in FIG. 15 and/or the computing system 4000 comprising a host machine 4002 as shown in FIG. 16 within which a set of machine instructions may be executed to perform any one or more of the methodologies discussed herein such as, for example, methods 400 (FIG. 4), 600 (FIG. 6), 700 (FIG. 7), or 900 (FIG. 9).

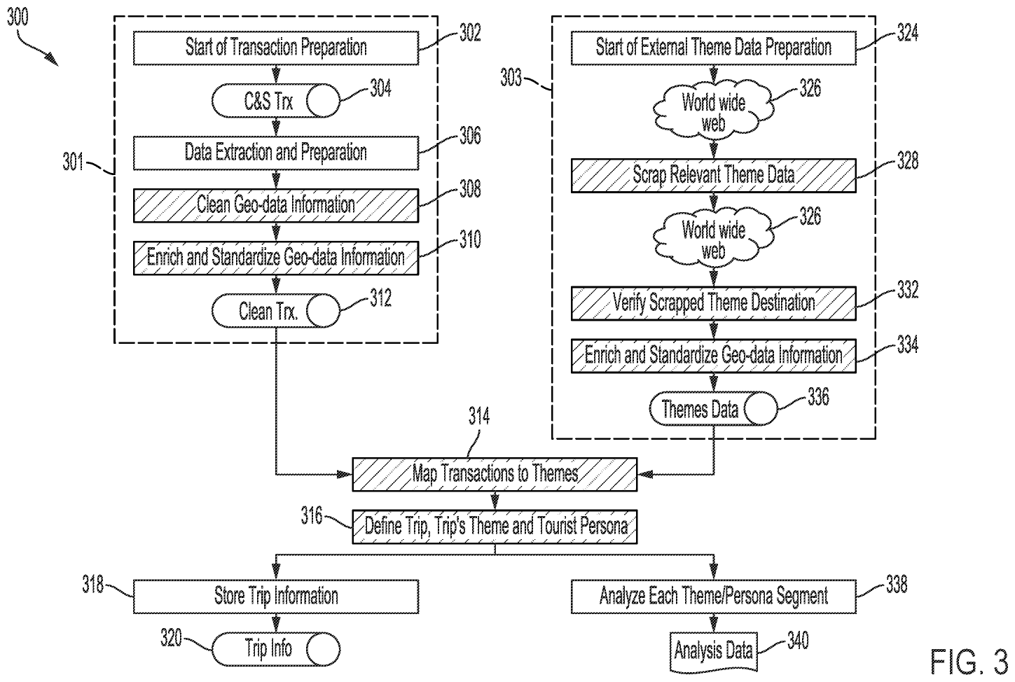

FIG. 3 is a diagram of an overall event driven system 300 for segmenting traveler thematic destination data, according to at least one aspect of the present disclosure. The event driven system 300 will be described as a transaction preparation method 301 associated with a trip and an external theme data preparation method 303 associated with the trip. The hardware and/or software components of the event driven system 300 such as, for example, methods 400 (FIG. 4), 600 (FIG. 6), 700 (FIG. 7), or 900 (FIG. 9), may be implemented in whole or in part by the computer apparatus 3000 comprising data processing subsystems or components shown in FIG. 15 and/or the computing system 4000 comprising a host machine 4002 as shown in FIG. 16 within which a set of machine instructions may be executed to perform any one or more of the methodologies discussed herein.

The transaction preparation method 301 associated with the trip prepares 302 a transaction and retrieves clearance and settlement (C&S) transaction data (FIG. 2) from a C&S database 222, which includes transactions made by a customer and information about the transaction place, e.g., the geographical location, where the transaction occurred. The C&S transaction data is stored 304 in the C&S database 222 on the database layer 206 (FIG. 2) of the system 200 shown in FIG. 2. Using the place of the transaction and additional information obtained from the external data sources 202 (FIG. 2), thematic information about the trip can be scraped, cleaned, and normalized. Thus, if a customer executes a transaction at a specific destination where this customer is probably located, such as a mountains area, the transaction preparation method 301 may be able to predict that the customer is interested in mountains as a theme and accordingly understand or map the behavior of the customer to a similar customer who would travel to a specific theme. C&S transaction data includes network operators routing messages and other information among financial institutions to facilitate payments between payers and payees. Interbank settlement is the discharge of obligations that arise in connection with faster payments either in real-time or on a deferred schedule.

The transaction preparation method 301 employs the C&S transaction data (FIG. 2) stored 304 in the C&S database 222, for example, Hadoop in the database layer 206 (FIG. 2). The C&S transaction data is processed by the processing layer 204 (FIG. 2) using Pyspark 216, Python® 218, and/or Hive 220 (see FIG. 2). The external data sources 202 (FIG. 2) generally include a plurality of generic websites as shown in FIG. 2. Any website relevant to an external data source 202 in terms of scraping data from the editable geographic databases 212 (e.g., OpenStreetMap®) and the location mapping applications 210 (e.g., Google® Maps), for example, can be used to search for the geo-data to determine geographic location and later normalize the location or search for a specific place. A search engines 208, such as Google® Search through Selenium (FIG. 2), may be used for spelling checks and correcting spelling mistakes for the transaction places by employing various aspects of text permutations, for example. In one example, the processing layer 202 may utilize location data and external data sources 202 to differentiate between a common misspelling of Columbia and Colombia. The processing layer 202 may determine that that the geographic location information of interest is for the country of Colombia rather than the city of Columbia, South Carolina, USA.

The transaction preparation method 301 employs two data sources, the C&S transactions data, that may be data associated with a payment system network used in the transaction, and external data sources 202 (FIG. 2). The two external data sources 202 can be used to create a theme database 226 of the transaction place with specific theme such as for example, neighborhoods, cities, and so on.

The transaction preparation method 301 extracts and prepares 306 the C&S transaction data and subsequently cleans 308 the geo-data information obtained from the C&S transaction data. The cleaned geo-data information is then enriched and standardized 310 before it is stored 312 in a clean transaction database 224. For example, the processing of enriching and standardizing the transaction data may include setting the transaction place at a neighborhood level and the theme may be at a country level. If the city is near a seashore, but the seashore itself is an island, which is a touristic destination as a whole, and the island is a country, then the whole country is an island. The transaction preparation method 301 may employ the cleaned geo-data information to enrich and standardize 310 additional geographical information. For example, a specific city may have multiple pronunciations or may be defined by a different polygon shape on different maps and may not be mapped correctly. Accordingly, the same external data sources 202 may be employed to execute the standardization function in order to map the two locations. One aspect of a method 400 for cleaning, and enriching and standardizing geo-data information associated with a trip is further described with reference to FIG. 4.

After cleaning 308, enriching and standardizing 310 the geo-data information, using, for example, the process described with reference to FIG. 4, the event driven system 300 shown in FIG. 3 executes the external theme data preparation method 303 prepares 324 external theme data obtained from external data sources 202 (FIG. 2) from a public network such as the Internet/World Wide Web website 326, for example. Theme data include beaches (may include sub-themes based on Caribbean or European beaches), mountains (may include sub-themes based on elevation), cityscapes, national parks, historically significant locations, UNESCO world heritage sites, and islands, for example. The method 303 scrapes 328 any relevant theme data from the Internet/World Wide Web website 326 depending on the type of theme being extracted. For instance, if the theme is about mountains, the external theme data preparation method 303 scrapes 328 specific websites that discuss mountains. In one scenario, Wikipedia website data is searched and scraped 328 for relevant mountain theme data. The process is scalable such that if a website with the relevant theme information exists, the external theme data preparation method 303 may obtain the relevant theme information directly, otherwise the external theme data preparation method 303 will search for more generic mountain themes from websites where the relevant information may be obtained. The theme data preparation method 303 generally stores 336 theme data in the theme database 226, and is later refined based on the cleaned C&S transaction data 312, stored in the cleaned C&S database 224.

It will be appreciated, that an Internet/World Wide Web website 326, which scrapes for the relevant theme data, may turn up large lists of themes. For example, a scrape of relevant websites may return a list of 2,000,000 beach destinations. However, not all of the scraped 328 theme destination data results are actually practical destinations or locations, or may identify outdated information for a beach that is now closed. Thus, using the Internet/World Wide Web website 326, the external theme data preparation method 303 verifies 332 the scraped 328 relevant theme destination data. The output provides information to confirm whether the relevant theme destination is currently active and that it is a current touristic destination. For instance, the scraped 328 relevant theme destination data may include a specific island that is mountainous and uninhabitable. This result would be deemed irrelevant and the verification process would continue using other Internet/World Wide Web website 326. Once the scraped 328 relevant theme destination data is verified 332, the external theme data preparation method 303 enriches and standardizes 334 the geo-data information and stores 336 it in a theme database 338 to create a theme data repository. One aspect of a method 600 for creating a theme data repository is described with reference to FIG. 6.

With reference now back to FIG. 4, after cleaning the geo-data information using the method 400 described with reference to FIG. 4 and creating the theme database 226 using the method 600 described with reference to FIG. 6, and now returning to FIG. 3, the event driven system 300 is configured to map 314 the transaction place data to the transaction theme data using geographical methods such that if the customer is within an area, the event driven system 300 may consider that the customer is probably a tourist, for example, among similar sorts of themes.

Still with reference to FIG. 3, after mapping 314 the transaction data to the theme data, the event driven system 300 defines 316 the customer trip, the trip theme, and traveler segment based on the clean customer transaction data 312 and the trip theme data 336. In addition to mapping the theme according to the theme data 336, the event driven system 300 also may include additional information about the behavior of the customer and mapping that customer to a specific type of tourist. For instance, the event driven system 300 may identify that the transactions and behaviors of the customer are indicative of a tourist who is a student or a medical tourist, and so on. Thus, the system 300 maps the customer to one of plurality of potential tourist personas. The event driven system 300 stores 318 trip information in a trip information database 320 and analyzes 338 each theme and traveler segment and stores the analysis data in a database 340.

FIG. 4 illustrates a method 400 for cleaning and standardizing geo-data information associated with a trip, according to at least one aspect of the present disclosure. After determining 402 the transaction place based on the C&S transaction data, the method 400 searches 404 for the transaction place on a public geographic database service 212 such as, for example, OpenStreetMap® 212 (OSM) (FIG. 2), one of the external data sources 202 (FIG. 2), and determines 406 whether the transaction place actually exists in the transaction country. In one aspect, when searching the editable geographic databases 212 (e.g., OSM) and external data sources, information is obtained for the whole hierarchy of locations in addition to the polygon shape of the map. For instance, any map defines some sort of polygon that highlights the boundaries of that transaction place (e.g., metropolitan area of a city or bounties of a country.

If the transaction place actually exists in the transaction country, the method 400 extracts 434 the standardized geo-data about the transaction place and stores 436 the clean transaction geo-data in a clean transaction database 438 (224 of FIG. 2). If the transaction place does not exist in the transaction country, the method 400 determines 408 whether the transaction place has a missing letter. If the transaction place is not found, for instance, the method 400 assumes something is wrong, such as, for example, a missing letter, a misspelling, may be known by another name, has a non-English letter, or anything of the sort. As described below, the method 400 checks whether it has some sort of missing letters in it or not. If it does, then the method 400 performs text permutations by substituting, adding, or removing letters and conducts additional searches on the editable geographic databases 212 (e.g., OSM).

Accordingly, if the transaction place has missing or additional letters, the method 400 starts 420 a country level text permutation, searches 422 for the transaction place on the editable geographic databases 212 (e.g., OSM), and determines 424 whether the transaction exists in the transaction country. If the transaction place actually exists in the transaction country, the method 400 extracts 434 the standardized geo-data about the transaction place and stores 436 the cleaned transaction geo-data in the transaction database 224. If the transaction place does not exist in the transaction country, the method 400 searches 410 a search engine 208 (e.g., Google®), and determines 412 whether the search engine 208 (e.g., Google®) found a spelling correction. Here, the method 400 performs a text permutation, replaces the misspelled letter with another letter, and continue searching for the transaction place on the editable geographic databases 212 (e.g., OSM). If the transaction place exists on the editable geographic databases 212 (e.g., OSM), the method 400 accepts the replacement letter. If the transaction place does not exist on the editable geographic databases 212 (e.g., OSM), the method 400 substitutes a second letter, and so on for the remainder of the process.

Accordingly, if the search engine 208 (e.g., Google®, Bing®) successfully provides the correct spelling, the method 400 searches 426 for the transaction place on the editable geographic databases 212 (e.g., OSM) and determines 428 whether the transaction place actually exists in the transaction country. If the transaction place actually exists in the transaction country, the method 400 extracts 434 the standardized geo-data about the place, and stores 436 the clean transaction geo-data in the transaction database 312. If the transaction place does not exist in the transaction country, the method 400 searches 414 for the transaction place on a location mapping application (e.g., Google maps) and determines 416 whether the transaction place actually exists in the transaction country.

If the transaction place actually exists in the transaction country, the method 400 searches 430 for the coordinates on the editable geographic database 212 (e.g., OSM). If the transaction place does not exist in the transaction country, the method 400 retrieves 418 the transaction place GMR location, and searches 430 for the coordinates of the transaction place on the editable geographic databases 212 (e.g., OSM). Once again, the method 400 determines 432 whether the transaction place actually exists in the transaction country and if not, the method 400 ends 440 the process. If the transaction place actually exists in the transaction country, the method 400 extracts 434 the standardized geo-data about the transaction place, and stores 436 the clean transaction geo-data in the transaction database 312.

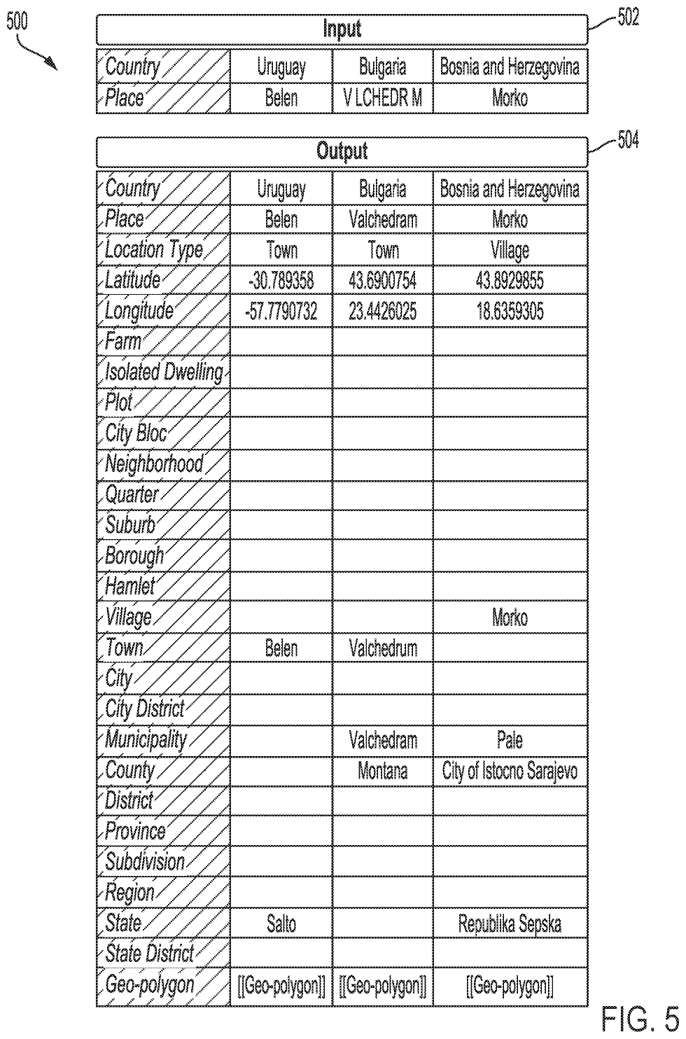

FIG. 5 is a chart 500 of clean transaction geo-data information output data structure generated according to the method 400 shown in FIG. 4, according to at least aspect of the present disclosure. The input data structure 502 is shown on the left and the clean geo-data information output data structure 504 is shown on the right. The clean geo-data output data structure 504 is stored (436 in FIG. 4) in the clean transaction database (438 of FIG. 4; 224 of FIG. 2). As shown in FIG. 5, the clean geo-data information output data structure 504 provides a much richer (e.g., enriched) and standardized data set. In summary, the transaction place geo-data information is cleaned by spelling correction using country level text permutations and the search engine 208 (e.g., Google®). The geo-data information is enriched by identifying the type of place, e.g., town, village, state, etc., creating a geo-polygon of the transaction place to define its boundaries on the map, and getting the coordinates and less granular information about the location place. Finally, the transaction place standardization includes standardizing different spellings of the same place into single mean.

FIG. 6 illustrates a method 600 for creating a theme database, according to at least one aspect of the present disclosure. The method 600 scrapes unstructured text data 602, the theme information associated with a trip, from a public network such as, for example, Internet/World Wide Web websites 326, as discussed in connection with FIGS. 2 and 3. The method 600 searches 604 the transaction place, e.g., location, on Internet/World Wide Web websites 326, and determines 606 whether the transaction place is touristic, for example, and relevant to the theme. If the transaction place is not touristic and relevant to the theme, the method 600 ends 614 the process.

If the transaction place is touristic and relevant to the theme, the method 600 continues searches 608 for the transaction place on the editable geographic databases 212 (e.g., OSM). The method 600 stores the standardized geo-data associated with the transaction place; extracts 610 the clean transaction geo-data, and stores 612 the clean transaction geo-data in the theme database 614 (226 of FIG. 2).

FIG. 7 illustrates an exemplary method 700 for creating a beaches themed data repository, within the theme database, according to at least one aspect of the present disclosure. The method 700 searches 704 the external source (e.g., Wikipedia website) 702 for all beachfront keywords and scrapes 706 the Wikipedia page for information relevant to the keyword search 704. The method 700 then makes three separate determinations. The method 700 determines 708 whether the Wikipedia description indicates a beachfront, determines 710 whether the Wikipedia summary indicates a beachfront, and determines 712 whether the Wikipedia page has tourism and beach sections. If any of the three determinations 708, 710, 712 indicate no, the method 700 ends 716 the process. If any of the three determinations 708, 710, 712 indicate yes, the method 700 searches 718 the Google® travel page using Selenium, and scrapes 720 the Google® travel page for destination. The method 700 then determines 722 whether the destinations scraped from the Google® travel page include travel destinations with beaches. If not, the method 700 ends 716 the process. If the destinations scraped from the Google® travel include travel destinations with beaches, the method 700 searches 724 for the transaction place on the editable geographic databases 212 (e.g., OSM), extracts 726 standardized geo-data about the transaction place, and stores 728 the clean transaction geo-data in the theme database 730.

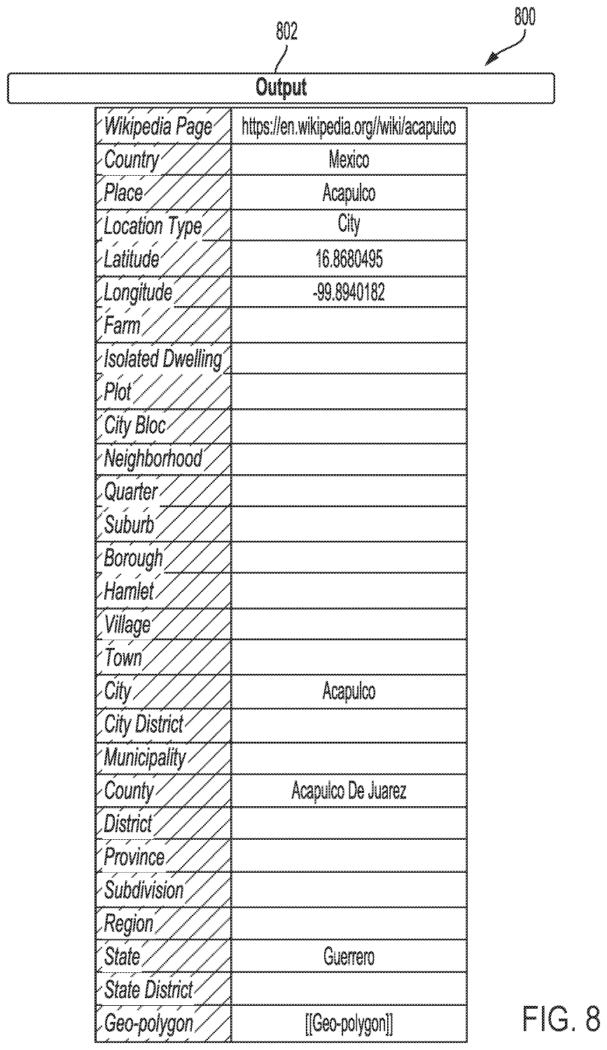

FIG. 8 is an example data entry 800 of a beaches themed data stored in the beach theme data repository, within the theme database, created according to the method 700 shown in FIG. 7, according to at least aspect of the present disclosure. The data structure 802 is the output of the method 700 that is stored 336 in the theme database 338 (FIG. 7).

In summary, the method 600 of creating the theme database creation shown in FIG. 6 and the method 700 of creating a beaches themed data repository shown in FIG. 7 include creating a destination repository using text analysis of scraped data for identifying travel destinations for each theme and verifying a travel destination database through automated secondary research. The methods 600, 700 also include enriching data by identifying the type of place, e.g., town, village, state, etc., creating a geographic polygon of the place to define its boundaries on the map, and obtaining coordinates and less granular information about the transaction place.

FIG. 9 is a method 900 of mapping themes to transactions, according to at least one aspect of the present disclosure. After enriching and standardizing 310 the cleaned geo-data information and storing it in the clean transaction database 312 and after enriching and standardizing 334 the geo-data information and storing 336 it in the theme database 338 (see FIG. 3) the method 900 maps the theme to the transactions. The method 900 compares 906 the geographic polygons between the transaction normalized place 902 and the destination normalized place and determines 908 whether the destination tagging is at a country level.

If the destination tagging is at a country level, the method 900 determines 910 whether the transaction and destination share the same country. If not, the method 900 ends 912 the process. If the transaction and destination share the same country, the method 900 labels 914 the transaction with the theme type and stores 916 the clean transaction geo-data in the theme database 918.

If the destination tagging is not at a country level, the method determines 920 whether the geographic polygons of transaction and destination overlay. If there is an overlay, the method 900 labels 914 the transaction with the theme type and stores 916 the clean transaction geo-data in the theme database 918. If there is no overlay of the geographic polygons of the transaction and destination, the method 900 calculates 922 the Haversine distance between the coordinates of destination and transaction. The method 900 then determines 924 whether the distance between transaction place and destination place is within range.

If the distance between transaction place and destination place is within range, the method 900 labels 914 the transaction with the theme type and stores 916 the clean transaction geo-data in the theme database 918. If the distance between transaction place and destination place is not within range, the method 900 ends 926 the process.

In summary, the theme transaction mapping method 900 maps the transaction to the theme. The method 900 uses geographic analysis for querying and identifying a theme for each transaction and calculating geographic distance between the theme and the transaction to identify a nearby theme.

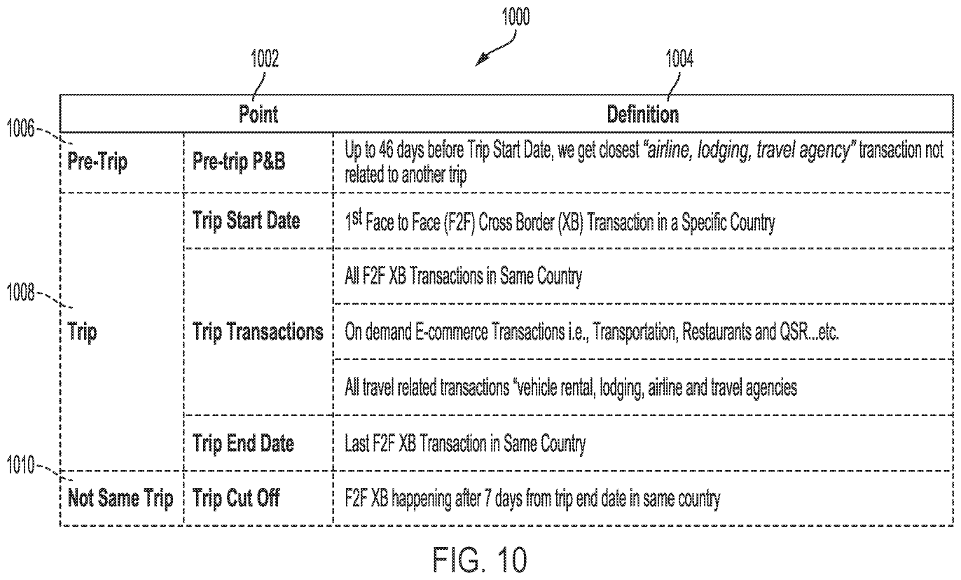

FIG. 10 is a chart 1000 showing definitions created based on transaction sequences, according to at least one aspect of the present disclosure. The chart 1000 is divided between point 1002 and definition 1004 and identifies different points in time such as pre-trip, trip, not same trip. The pre-trip point 1006 includes pre-trip planning and budgeting (P&B) and trip start date and corresponding definitions. The trip point 1008 includes trip transactions and trip end date and corresponding definitions. The not same trip point 1010 includes the trip cut off and a corresponding definition.

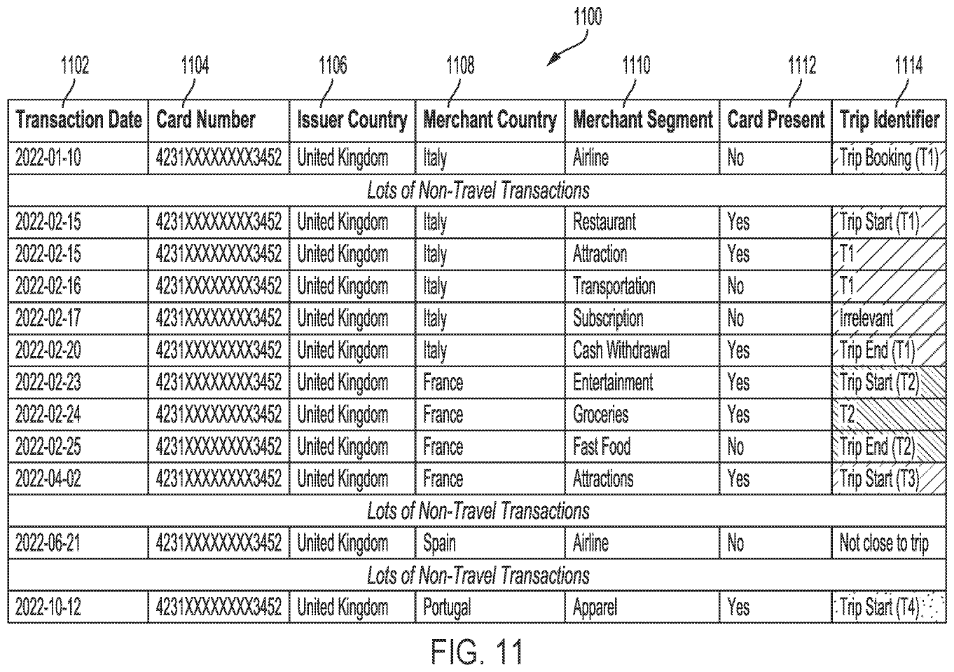

FIG. 11 is an example trip definition table 1100, according to at least one aspect of the present disclosure. The table 1100 is divided into several columns including Transaction Date 1102, Card Number 1104, Issuer Country 1106, Merchant Country 1108, Merchant Segment 1110, Card Present 1112, and Trip Identifier 1114.

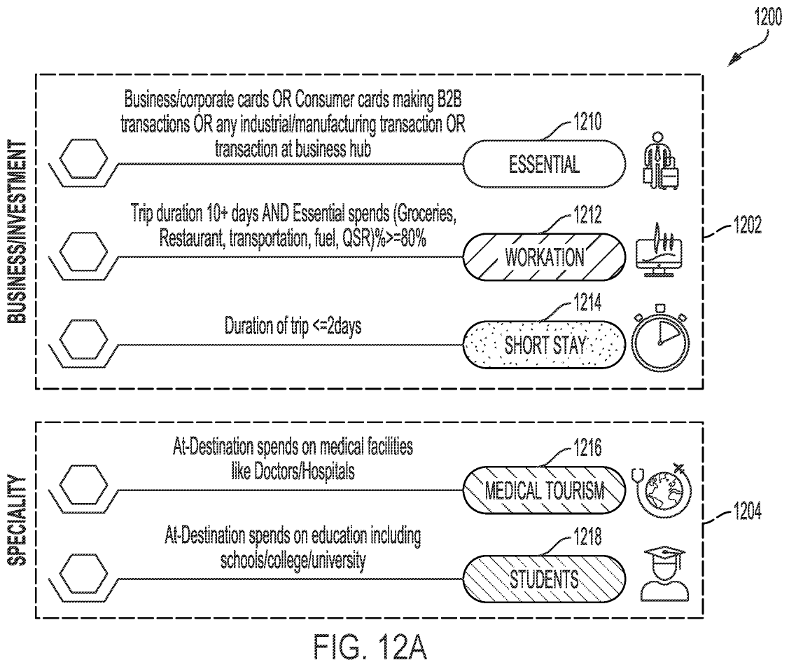

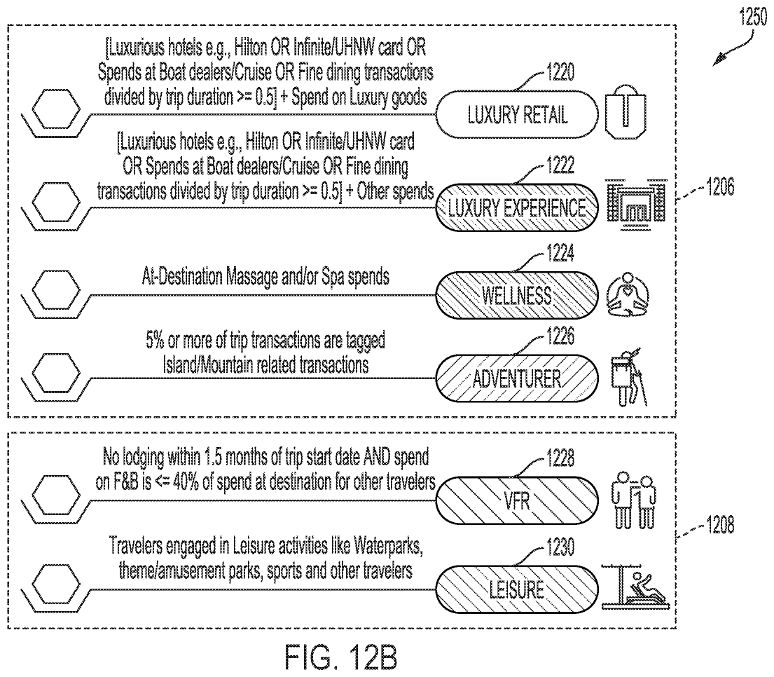

FIGS. 12A and 12B show a first chart 1200 and a second chart 1250 defining the purpose of a trip, according to at least one aspect of the present disclosure. The FIGS. 12A and 12B show four travel segments as shown by the first chart 1200 including segments for business/investment 1202 and specialty 1204, and the second chart 1250 including segments for experience 1206, and leisure/entertainment 1208 type of trips.

The business/investment 1202 trip segment includes essential 1210, Workation® 1212, and short-stay 1214 type trips. Essential 1210 trips include information such as, for example, business/corporate cards or consumer cards making business-to-business (B2B) transactions or any industrial/manufacturing transaction or transaction at business hub. Workation® 1212 trips include information such as, for example, a trip duration of 10 or more days and essential spends (e.g., groceries, restaurants, transportation, fuel, QSR) %>=80%. Short-stay trips 1214 may be defined, for example, as trips lasting <=2 days.

The specialty trip segment 1204 includes medical tourism 1216 and student type trips 1218. Medical tourism trips 1216 include information such as, for example, at-destination spends on medical facilities like doctors/hospitals. Student trips 1218 include information such as, for example, at-destination spends on education including schools/college/university.

The experience trip segment 1206 includes luxury retail 1220, luxury experience 1222, wellness 1224, and adventurer 1226 type trips. Luxury retail 1220 transactions include spends at luxurious hotels, e.g., Hilton or infinite/ultra-high-net-worth client (UHNW) card or spends at boat dealers/cruise or fine dining transactions divided by trip duration >=0.5 and spends on luxury goods. Luxury experience 1222 transactions include spends at luxurious hotels, e.g., Hilton or infinite/UHNW card or spends at boat dealers/cruise or fine dining transactions divided by trip duration >=0.5 and other spends. In one example, wellness transactions 1224 may include at-destination massage and/or spa spends. In one example, adventurer transactions 1226 include spends of 5% or more of trip transactions tagged as island/mountain related transactions.

The leisure/entertainment 1208 trip segment includes VFR 1228 (visiting friends and relatives) and leisure 1230 type trips. VFR 1228 transactions include spends with no lodging within 1.5 months of trip start date and spends on food and beverages of <=40% of spend at destination for other travelers. Leisure 1230 transactions include travelers engaged in leisure activities like waterparks, theme/amusement parks, sports and other travelers.

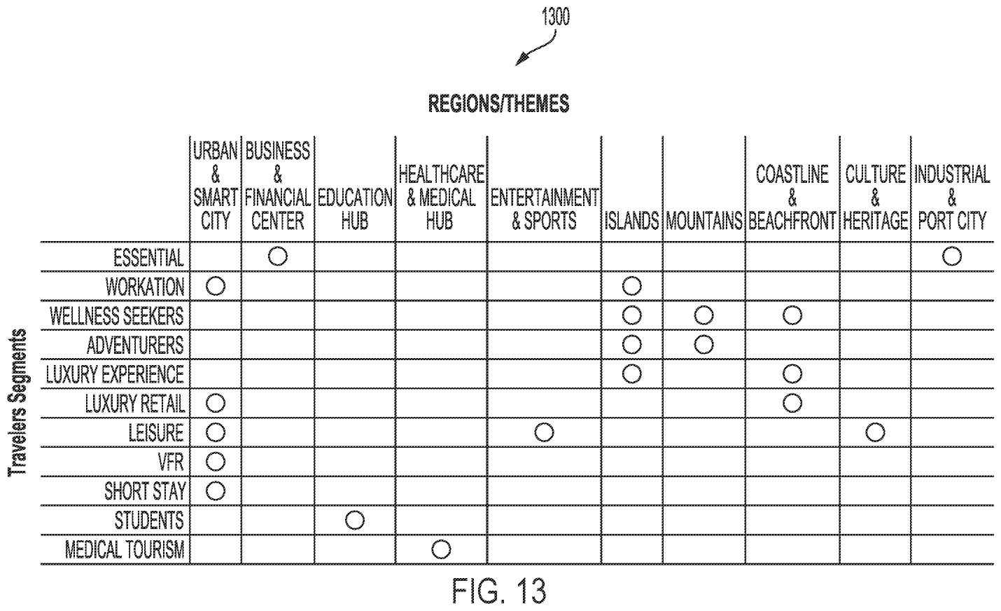

FIG. 13 is an output chart 1300 depicting a combination of destination theme and trip reason, according to at least one aspect of the present disclosure. The vertical portion of the chart 1300 tabulates traveler segments and the horizontal portion of the chart 1300 tabulates regions/themes. The traveler segments include, for example, essential, Workation®, wellness seekers, adventurers, luxury experience, luxury retail, leisure, VFR, short-stay, students, and medical tourism. The regions/themes include, for example, urban and smart city, business and financial center, education hub, healthcare and medical hub, entertainment and sports, islands, mountains, coastline and beachfront, culture and heritage, and industrial and sport city. The dots indicate where the traveler segment intersects with the regions/themes.

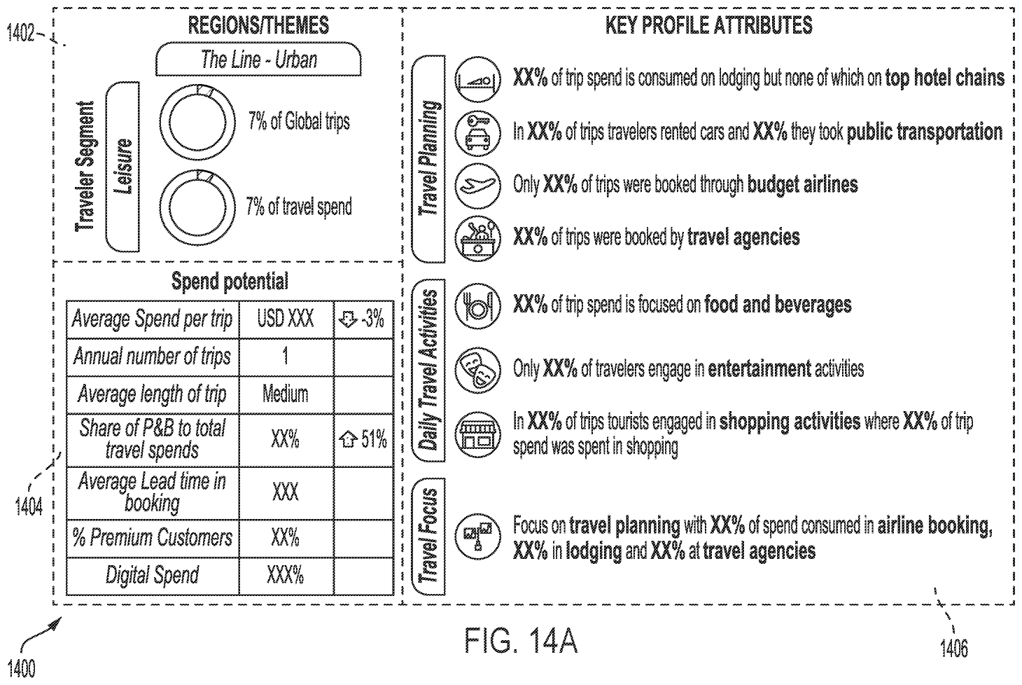

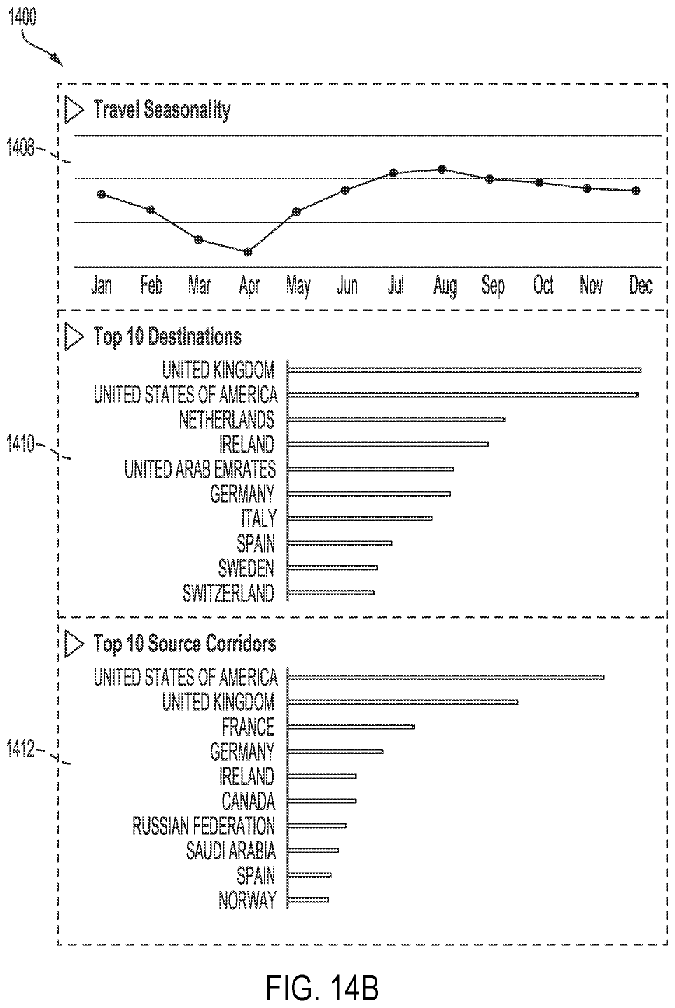

FIGS. 14A and 14B are an exemplary analysis report diagram 1400 illustrating profile data based on trips, according to at least one aspect of the present disclosure. The chart 1400 includes traveler segments versus regions/themes section 1402, a spend potential section 1404, a key profile attributes section 1406, a travel seasonality section 1408, a top 10 destinations section 1410, and a 10 source corridors section 1412. The exemplary output diagram 1400 illustrating profile data may be generated as output analysis data (340 of FIG. 3) through a user interface (FIG. 15). In one example, a user or client may subscribe to automatically receive the output analysis data based on input criterion for a specific location or segment.

FIG. 15 is a block diagram of a computer apparatus 3000 comprising data processing subsystems or components, according to at least one aspect of the present disclosure. The subsystems shown in FIG. 15 are interconnected via a system bus 3010. Additional subsystems such as a printer 3018, keyboard 3026, fixed disk 3028 (or other memory comprising computer-readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer-readable medium.

FIG. 16 is a diagrammatic representation of an example computing system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other, via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4028 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the system or method according to various aspects of the present disclosure are provided below and may include any one or more than one, and any combination thereof.
Clause 1. An event driven system for traveler thematic destination segmentation, the event driven system comprising: a processor; a memory coupled to the processor, wherein the memory stores machine instructions executable by the processor; wherein when executed by the processor the machine instructions cause the processor to: extract clearance and settlement transaction data from a clearance and settlement database; prepare the clearance and settlement transaction data; clean geo-data associated with the clearance and settlement transaction data; enrich and standardize the geo-data associated with the clearance and settlement transaction data; scrape relevant theme data associated with a trip from a public network; verify the relevant theme data associated with the trip; enrich and standardize geo-data associated with the relevant theme data associated with the trip; and map the enriched and standardized geo-data associated with the clearance and settlement transaction data to the enriched and standardized geo-data associated with the relevant theme data associated with the trip.
Clause 2. The event driven system of clause 1, wherein when executed by the processor the machine instructions cause the processor to: store the enriched and standardized geo-data associated with the clearance and settlement transaction data in a first database; and store the enriched and standardized geo-data associated with the relevant theme data associated with the trip in a second database.
Clause 3. The event driven system of clause 2, wherein when executed by the processor the machine instructions cause the processor to: retrieve the enriched and standardized geo-data associated with the clearance and settlement transaction data from the first database; and retrieve the enriched and standardized geo-data associated with the relevant theme data associated with the trip from the second database.
Clause 4. The event driven system of any one of clauses 1-3, wherein when executed by the processor the machine instructions cause the processor to: define at least one of a trip, a trip theme, or a traveler segment; store trip information in a third database; analyze each theme and traveler segment to generate analysis data; and store the analysis data in a fourth database.
Clause 5. An event driven method for traveler thematic destination segmentation, the method comprising: extracting, by a processor, clearance and settlement transaction data from a clearance and settlement database; preparing, by the processor, the clearance and settlement transaction data; cleaning, by the processor, geo-data associated with the clearance and settlement transaction data; enriching and standardizing, by the processor the geo-data associated with the clearance and settlement transaction data; scraping, by the processor, relevant theme data associated with a trip from a public network; verifying, by the processor, the relevant theme data associated with the trip; enriching and standardizing, by the processor, geo-data associated with the relevant theme data associated with the trip; and mapping, by the processor, the enriched and standardized geo-data associated with the clearance and settlement transaction data to the enriched and standardized geo-data associated with the relevant theme data associated with the trip.
Clause 6. The event driven method of clause 5, comprising: storing, by the processor, the enriched and standardized geo-data associated with the transaction data in a first database; and storing, by the processor, the enriched and standardized geo-data associated with the relevant theme data associated with the trip in a second database.
Clause 7. The event driven method of clause 6, comprising: retrieving, by the processor, the enriched and standardized geo-data associated with the transaction data from the first database; and retrieving the enriched and standardized geo-data associated with the relevant theme data from the second database.
Clause 8. The event driven method of any one of clauses 5-7, comprising: defining, by the processor, at least one of a trip, a trip theme, or traveler segment; storing, by the processor, trip information in a third second database; analyzing, by the processor, each trip, theme, or persona segment to generate analysis data; and storing, by the processor, the analysis data in a fourth database.
Clause 9. The event driven method of any one of clauses 5-8 wherein the cleaning, by the processor, of the geo-data associated with the transaction data comprises determining, by the processor, a transaction place; searching, by the processor, for the transaction place on a public geographic database service; determining, by the processor, whether the transaction place exists in a transaction country; performing, by the processor, text permutations on the transaction place; performing, by the processor, text permutations on the transaction country; extracting, by the processor, standardized geo-data about the transaction place; and storing, by the processor, clean transaction geo-data in the first database.
Clause 10. The event driven method of any one of clauses 5-9, comprising: retrieving, by the processor, Global Merchant Repository (GMR) location of the transaction place; and searching, by the processor, for coordinates of the transaction place on the public geographic database service.
Clause 11. The event driven method of any one of clauses 5-10, comprising creating, by the processor, a theme database.
Clause 12. The event driven method of clause 11, comprising: searching, by the processor, unstructured data on the public network; determining, by the processor, whether a transaction place is touristic and relevant to a theme; searching, by the processor, on the public geographic database service.
Clause 13. The event driven method of any one of clauses 5-12, comprising: retrieving, by the processor, a normalized transaction place; retrieving, by the processor, a normalized destination place; and comparing, by the processor, geographic polygons associated with the normalized transaction place and the normalized destination place.
Clause 14. The event driven method of clause 13, comprising: determining, by the processor, whether the normalized transaction place and the normalized destination place share a country; if the normalized transaction place and the normalized destination place share a country, the event driven method further comprises: labeling, by the processor, the transaction with a theme type; storing, by the processor, clean transaction geo-data in the first database.
Clause 15. The event driven method of any one of clauses 13-14, comprising: determining, by the processor, whether there is an overlay between the geographic polygons associated with the normalized transaction place and the normalized destination place; calculating, by the processor, a Haversine distance between coordinates of the normalized transaction place and the normalized destination place; and if the distance between the normalized transaction place and the normalized destination place is within a predetermined range, the event driven method further comprises: labeling, by the processor, the transaction with a theme type; and storing, by the processor, clean transaction geo-data in the first database.
Clause 16. An event driven system for segmenting traveler thematic destination data, the event driven system comprising: a processor; a memory coupled to the processor, wherein the memory stores machine instructions executable by the processor; wherein when executed by the processor the machine instructions cause the processor to: extract clearance and settlement transaction data from a clearance and settlement database; clean geo-data associated with the clearance and settlement transaction data; enrich and standardize the geo-data associated with the clearance and settlement transaction data; scrape theme data associated with a plurality of predefined destination themes from a public network; verify the theme data is relevant for a geographic location corresponding to geo-data associated with of the theme data; enrich and standardize the geo-data associated with the theme data; map the enriched and standardized geo-data associated with the clearance and settlement transaction data to the enriched and standardized geo-data associated with the theme data to create analysis data based on the clearance and settlement transaction data; and generate an analysis report based on the analysis data and an input criterion.
Clause 17. The event driven system of claim 16, wherein when executed by the processor the machine instructions cause the processor to: store the enriched and standardized geo-data associated with the clearance and settlement transaction data in a first database; and store the enriched and standardized geo-data associated with the theme data associated with the plurality of predefined destination themes in a second database.
Clause 18. The event driven system of claim 17, wherein when executed by the processor the machine instructions cause the processor to: retrieve the enriched and standardized geo-data associated with the clearance and settlement transaction data from the first database; and retrieve the enriched and standardized geo-data associated with the theme data associated with the plurality of predefined destination themes from the second database.
Clause 19. The event driven system of claim 17, wherein when executed by the processor the machine instructions cause the processor to: define trip information based on the enriched and standardized geo-data associated with the clearance and settlement transaction data, wherein the trip information comprises at least one of a trip, a trip theme of the plurality of predefined destination themes, or a traveler segment of a plurality of predefined traveler segments; analyze the trip information based on each of the plurality of predefined destination themes and traveler segments to generate the analysis data; and store the trip information and analysis data in a third database.
Clause 20. The event driven system of claim 19, wherein the input criterion is a location or a first traveler segment of the plurality of predefined traveler segments.
Clause 21. An event driven method for traveler thematic destination segmentation, the method comprising: extracting, by a processor, clearance and settlement transaction data from a clearance and settlement database; cleaning, by the processor, geo-data associated with the clearance and settlement transaction data; enriching and standardizing, by the processor the geo-data associated with the clearance and settlement transaction data; scraping, by the processor, theme data associated with a plurality of predefined destination themes from a public network; verifying, by the processor, the theme data is relevant for a geographic location corresponding to geo-data associated with of the theme data; enriching and standardizing, by the processor, geo-data associated with the theme data; mapping, by the processor, the enriched and standardized geo-data associated with the clearance and settlement transaction data to the enriched and standardized geo-data associated with the theme data to create an analysis data based on the clearance and settlement transaction data; and generating, by the processor, an analysis report based on the analysis data and an input criterion.
Clause 22. The event driven method of claim 21, comprising: storing, by the processor, the enriched and standardized geo-data associated with the clearance and settlement transaction data in a first database; and storing, by the processor, the enriched and standardized geo-data associated with the theme data associated with the plurality of predefined destination themes in a second database.
Clause 23. The event driven method of claim 22, comprising: retrieving, by the processor, the enriched and standardized geo-data associated with clearance and settlement the transaction data from the first database; and retrieving the enriched and standardized geo-data associated with the theme data from the second database.
Clause 24. The event driven method of claim 22, comprising: defining, by the processor, trip information based on the enriched and standardized geo-data associated with the clearance and settlement transaction data, wherein the trip information comprises at least one of a trip, a trip theme of the plurality of predefined destination themes, or a traveler segment of a plurality of predefined traveler segments; analyzing, by the processor, the trip information based on each of the plurality of predefined destination themes and traveler segments to generate the analysis data; and storing, by the processor, the trip information and analysis data in a third database.
Clause 25. The event driven method of claim 24, wherein the input criterion is a location or a first traveler segment of the plurality of predefined traveler segments.
Clause 26. The event driven method of claim 22, wherein the cleaning, by the processor, of the geo-data associated with the clearance and settlement transaction data comprises determining, by the processor, a transaction place; searching, by the processor, for the transaction place on a public geographic database service; determining, by the processor, whether the transaction place exists in a transaction country; performing, by the processor, text permutations on the transaction place; performing, by the processor, text permutations on the transaction country; extracting, by the processor, standardized geo-data about the transaction place; and storing, by the processor, clean transaction geo-data in the first database.
Clause 27. The event driven method of claim 26, comprising: retrieving, by the processor, Global Merchant Repository (GMR) location of the transaction place; and searching, by the processor, for coordinates of the transaction place on a public geographic database service.
Clause 28. The event driven method of claim 21, comprising creating, by the processor, a theme database.
Clause 29. The event driven method of claim 28, comprising: searching, by the processor, unstructured data on the public network; determining, by the processor, whether a transaction place is touristic and to a theme; and searching, by the processor, on a public geographic database service.
Clause 30. The event driven method of claim 22, comprising: retrieving, by the processor, a normalized transaction place; retrieving, by the processor, a normalized destination place; and comparing, by the processor, geographic polygons associated with the normalized transaction place and the normalized destination place.
Clause 31. The event driven method of claim 30, comprising: determining, by the processor, whether the normalized transaction place and the normalized destination place share a country, wherein if the normalized transaction place and the normalized destination place share a country, the event driven method further comprising: labeling, by the processor, the clearance and settlement transaction data with a theme type; and storing, by the processor, clean transaction geo-data in the first database.
Clause 32. The event driven method of claim 30, comprising: determining, by the processor, whether there is an overlay between the geographic polygons associated with the normalized transaction place and the normalized destination place; calculating, by the processor, a Haversine distance between coordinates of the normalized transaction place and the normalized destination place; and wherein if the Haversine distance between the normalized transaction place and the normalized destination place is within a predetermined range, the event driven method further comprising: labeling, by the processor, the clearance and settlement transaction data with a theme type; and storing, by the processor, clean transaction geo-data in the first database.
Clause 33. A non-transitory computer-readable medium comprising instructions stored thereon, when executed by one or more processors, cause the one or more processors to: extract clearance and settlement transaction data from a clearance and settlement database; clean geo-data associated with the clearance and settlement transaction data; enrich and standardize the geo-data associated with the clearance and settlement transaction data; scrape theme data associated with a plurality of predefined destination themes from a public network; verify the theme data is relevant for a geographic location corresponding to geo-data associated with of the theme data; enrich and standardize geo-data associated with the theme data; map the enriched and standardized geo-data associated with the clearance and settlement transaction data to the enriched and standardized geo-data associated with the theme data to create an analysis data based on the clearance and settlement transaction data; and generate an analysis report based on the analysis data and an input criterion.
Clause 34. The non-transitory computer-readable medium of claim 33, wherein when executed by the one or more processors, cause the one or more processors to: define trip information based on the enriched and standardized geo-data associated with the clearance and settlement transaction data, wherein the trip information comprises at least one of a trip, a trip theme of the plurality of predefined destination themes, or a traveler segment of a plurality of predefined traveler segments; analyze the trip information based on each of the plurality of predefined destination themes and traveler segments to generate the analysis data; and store the trip information and analysis data in a first database.
Clause 35. The non-transitory computer-readable medium of claim 34, wherein the input criterion is a location or a first traveler segment of the plurality of predefined traveler segments.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer-readable medium, such as RAM, ROM, a magnetic medium such as a hard-drive or a floppy disk, or an optical medium such as a CD-ROM. Any such computer-readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer-readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. An event driven system for segmenting traveler thematic destination data, the event driven system comprising:
a processor;
a memory coupled to the processor, wherein the memory stores machine instructions executable by the processor;
wherein when executed by the processor the machine instructions cause the processor to:
extract clearance and settlement transaction data from a clearance and settlement database;
clean geo-data associated with the clearance and settlement transaction data;
enrich and standardize the geo-data associated with the clearance and settlement transaction data;
scrape theme data associated with a plurality of predefined destination themes from an external data source on a public network, wherein the processor scrapes the theme data in compliance with the terms and conditions of the external data source;
verify the theme data is relevant for a geographic location corresponding to geo-data associated with of the theme data;
enrich and standardize the geo-data associated with the theme data;
map the enriched and standardized geo-data associated with the clearance and settlement transaction data to the enriched and standardized geo-data associated with the theme data to create analysis data based on the clearance and settlement transaction data; and
generate an analysis report based on the analysis data and an input criterion.

2. The event driven system of claim 1, wherein when executed by the processor the machine instructions cause the processor to:
store the enriched and standardized geo-data associated with the clearance and settlement transaction data in a first database; and
store the enriched and standardized geo-data associated with the theme data associated with the plurality of predefined destination themes in a second database.

3. The event driven system of claim 2, wherein when executed by the processor the machine instructions cause the processor to:
retrieve the enriched and standardized geo-data associated with the clearance and settlement transaction data from the first database; and
retrieve the enriched and standardized geo-data associated with the theme data associated with the plurality of predefined destination themes from the second database.

4. The event driven system of claim 2, wherein when executed by the processor the machine instructions cause the processor to:
define trip information based on the enriched and standardized geo-data associated with the clearance and settlement transaction data, wherein the trip information comprises at least one of a trip, a trip theme of the plurality of predefined destination themes, or a traveler segment of a plurality of predefined traveler segments;
analyze the trip information based on each of the plurality of predefined destination themes and traveler segments to generate the analysis data; and
store the trip information and analysis data in a third database.

5. The event driven system of claim 4, wherein the input criterion is a location or a first traveler segment of the plurality of predefined traveler segments.

6. An event driven method for traveler thematic destination segmentation, the method comprising:
extracting, by a processor, clearance and settlement transaction data from a clearance and settlement database;
cleaning, by the processor, geo-data associated with the clearance and settlement transaction data;
enriching and standardizing, by the processor the geo-data associated with the clearance and settlement transaction data;
scraping, by the processor, theme data associated with a plurality of predefined destination themes from an external data source on a public network, wherein the processor scrapes the theme data in compliance with the terms and conditions of the external data source;
verifying, by the processor, the theme data is relevant for a geographic location corresponding to geo-data associated with of the theme data;
enriching and standardizing, by the processor, geo-data associated with the theme data;
mapping, by the processor, the enriched and standardized geo-data associated with the clearance and settlement transaction data to the enriched and standardized geo-data associated with the theme data to create an analysis data based on the clearance and settlement transaction data; and
generating, by the processor, an analysis report based on the analysis data and an input criterion.

7. The event driven method of claim 6, comprising:
storing, by the processor, the enriched and standardized geo-data associated with the clearance and settlement transaction data in a first database; and
storing, by the processor, the enriched and standardized geo-data associated with the theme data associated with the plurality of predefined destination themes in a second database.

8. The event driven method of claim 7, comprising:
retrieving, by the processor, the enriched and standardized geo-data associated with clearance and settlement the transaction data from the first database; and
retrieving the enriched and standardized geo-data associated with the theme data from the second database.

9. The event driven method of claim 7, comprising:
defining, by the processor, trip information based on the enriched and standardized geo-data associated with the clearance and settlement transaction data, wherein the trip information comprises at least one of a trip, a trip theme of the plurality of predefined destination themes, or a traveler segment of a plurality of predefined traveler segments;
analyzing, by the processor, the trip information based on each of the plurality of predefined destination themes and traveler segments to generate the analysis data; and
storing, by the processor, the trip information and analysis data in a third database.

10. The event driven method of claim 9, wherein the input criterion is a location or a first traveler segment of the plurality of predefined traveler segments.

11. The event driven method of claim 7, wherein the cleaning, by the processor, of the geo-data associated with the clearance and settlement transaction data comprises
determining, by the processor, a transaction place;
searching, by the processor, for the transaction place on a public geographic database service;
determining, by the processor, whether the transaction place exists in a transaction country;
performing, by the processor, text permutations on the transaction place;
performing, by the processor, text permutations on the transaction country;
extracting, by the processor, standardized geo-data about the transaction place; and
storing, by the processor, clean transaction geo-data in the first database.

12. The event driven method of claim 11, comprising:
retrieving, by the processor, Global Merchant Repository (GMR) location of the transaction place; and
searching, by the processor, for coordinates of the transaction place on a public geographic database service.

13. The event driven method of claim 6, comprising creating, by the processor, a theme database.

14. The event driven method of claim 13, comprising:
searching, by the processor, unstructured data on the public network;
determining, by the processor, whether a transaction place is touristic and to a theme; and
searching, by the processor, on a public geographic database service.

15. The event driven method of claim 7, comprising:
retrieving, by the processor, a normalized transaction place;
retrieving, by the processor, a normalized destination place; and
comparing, by the processor, geographic polygons associated with the normalized transaction place and the normalized destination place.

16. The event driven method of claim 15, comprising:
determining, by the processor, whether the normalized transaction place and the normalized destination place share a country, wherein if the normalized transaction place and the normalized destination place share a country, the event driven method further comprising:
labeling, by the processor, the clearance and settlement transaction data with a theme type; and
storing, by the processor, clean transaction geo-data in the first database.

17. The event driven method of claim 15, comprising:
determining, by the processor, whether there is an overlay between the geographic polygons associated with the normalized transaction place and the normalized destination place;
calculating, by the processor, a Haversine distance between coordinates of the normalized transaction place and the normalized destination place; and
wherein if the Haversine distance between the normalized transaction place and the normalized destination place is within a predetermined range, the event driven method further comprising:
labeling, by the processor, the clearance and settlement transaction data with a theme type; and
storing, by the processor, clean transaction geo-data in the first database.

18. A non-transitory computer-readable medium comprising instructions stored thereon, when executed by one or more processors, cause the one or more processors to:
extract clearance and settlement transaction data from a clearance and settlement database;
clean geo-data associated with the clearance and settlement transaction data;
enrich and standardize the geo-data associated with the clearance and settlement transaction data;
scrape theme data associated with a plurality of predefined destination themes from an external data source on a public network, wherein the processor scrapes the theme data in compliance with the terms and conditions of the external data source;
verify the theme data is relevant for a geographic location corresponding to geo-data associated with of the theme data;
enrich and standardize geo-data associated with the theme data;
map the enriched and standardized geo-data associated with the clearance and settlement transaction data to the enriched and standardized geo-data associated with the theme data to create an analysis data based on the clearance and settlement transaction data; and
generate an analysis report based on the analysis data and an input criterion.

19. The non-transitory computer-readable medium of claim 18, wherein when executed by the one or more processors, cause the one or more processors to:
define trip information based on the enriched and standardized geo-data associated with the clearance and settlement transaction data, wherein the trip information comprises at least one of a trip, a trip theme of the plurality of predefined destination themes, or a traveler segment of a plurality of predefined traveler segments;
analyze the trip information based on each of the plurality of predefined destination themes and traveler segments to generate the analysis data; and
store the trip information and analysis data in a first database.

20. The non-transitory computer-readable medium of claim 19, wherein the input criterion is a location or a first traveler segment of the plurality of predefined traveler segments.
